(19) United States
(12) Patent Application Publication
(10) Pub. No.: US 2011/0222233 A1
(43) Pub. Date: Sep. 15, 2011

(54) COMPUTER DEVICE WITH A MOVABLE PAD

(76) Inventors: Ying-Jia Lu, Taipei Hsien (TW); Chih-Yi Wang, Taipei Hsien (TW); Cheng-Hung Lin, Taipei Hsien (TW)

(21) Appl. No.: 12/898,683

(22) Filed: Oct. 5, 2010

(30) Foreign Application Priority Data
Mar. 15, 2010 (TW) 099107465

(51) Int. Cl. G06F 1/16

(52) U.S. Cl. 361/679.21; 361/679.59

(57) ABSTRACT

A computer device includes a first housing, a first magnetic component installed inside the first housing, a second housing connected to the first housing in a rotatable manner, and a pad mechanism connected to the second housing. The pad mechanism includes a sleeve connected to a bottom of the second housing, a pad installed inside the sleeve in a movable manner, an resilient component installed inside the sleeve in an extensible manner for driving the pad to protrude out of the sleeve, and a second magnetic component connected to the resilient component and the pad for attracting the first magnetic component so as to drive the pad to hide inside the sleeve.

### BACKGROUND OF THE INVENTION

1. Field of the Invention

The present invention relates to a computer device with a movable pad, and more specifically, to a computer device utilizing magnetic force and elastic force to drive a movable pad.

2. Description of the Prior Art

Since notebook computers become popular recently, notebook computers increasingly change in practicality and functionality. Appearance of notebook computers is progressed to thin and aesthetic to meet the customer's demands. In aspect of mechanism design of notebook computers, a pad disposed on a bottom of the notebook computer is for boosting the notebook computer to prevent the bottom of the notebook computer from wearing, and to enlarge a gap between the notebook computer and a supporting surface so as to improve convection under the notebook computer, such that heat-dissipating efficiency is increased in the notebook computer. Furthermore, the design of the pad mechanism can adjust a tilting angle of a keyboard of the notebook computer and increase a height of a display to reduce loading of a user's shoulders and neck while typing, so as to conform to the ergonomic design, such that the user can operate the notebook computer comfortably. However, when the notebook computer is not in use, appearance may be affected by thickness of the pad, and it is a defect of the pad design.

### SUMMARY OF THE INVENTION

The present invention provides a computer device utilizing magnetic force and elastic force to drive a movable pad to solve the problems mentioned above.

According to the claimed invention, a computer device includes a first housing, a first magnetic component installed inside the first housing, a second housing connected to the first housing in a rotatable manner, and a pad mechanism connected to the second housing. The pad mechanism includes a sleeve connected to a bottom of the second housing, a pad installed inside the sleeve in a movable manner, an resilient component installed inside the sleeve in an extensible manner for driving the pad to protrude out of the sleeve, and a second magnetic component connected to the resilient component and the pad for attracting the first magnetic component so as to drive the pad to hide inside the sleeve.

According to the claimed invention, a thread structure is disposed on the sleeve for screwing the second housing.

According to the claimed invention, the pad hides inside the sleeve when attractive force between the second magnetic component and the first magnetic component is greater than elastic force applied to the second magnetic component by the resilient component, and the pad protrudes out of the sleeve when attractive force between the second magnetic component and the first magnetic component is less than elastic force applied to the second magnetic component by the resilient component.

According to the claimed invention, the pad completely hides inside the sleeve when the first housing and the second housing are substantially parallel.

According to the claimed invention, the first magnetic component and the second magnetic component are respectively a magnet.

According to the claimed invention, the resilient component is a spring.

According to the claimed invention, the first housing is a display housing.

According to the claimed invention, the second housing is a host housing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams of a computer device in open and close states according to a preferred embodiment of the present invention.

FIG. 3 is an assembly diagram of a pad mechanism according to the preferred embodiment of the present invention.

FIG. 4 is an exploded diagram of the pad mechanism according to the preferred embodiment of the present invention.

FIG. 5 and FIG. 6 are schematic diagrams of inner structure of the computer device in open and close states according to the preferred embodiment of the present invention.

### DETAILED DESCRIPTION

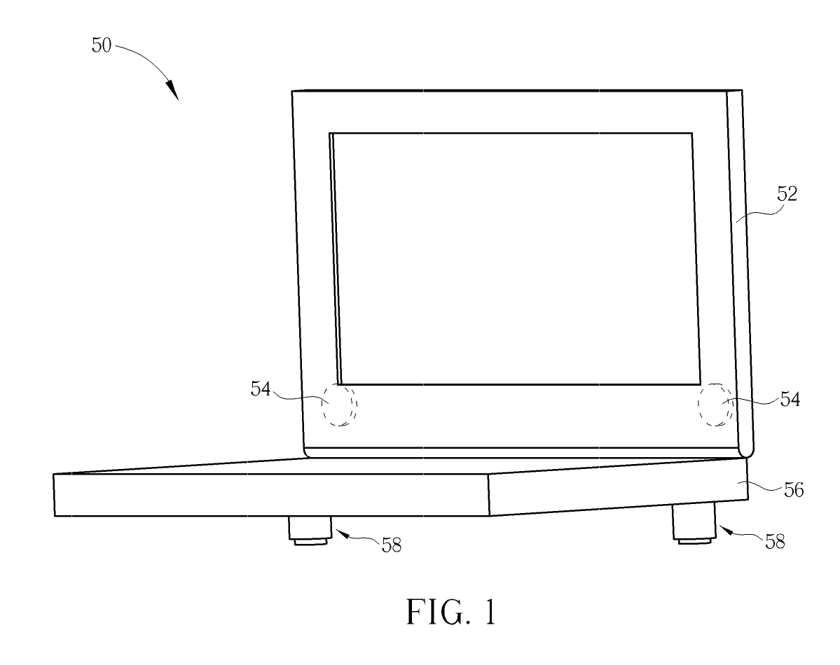

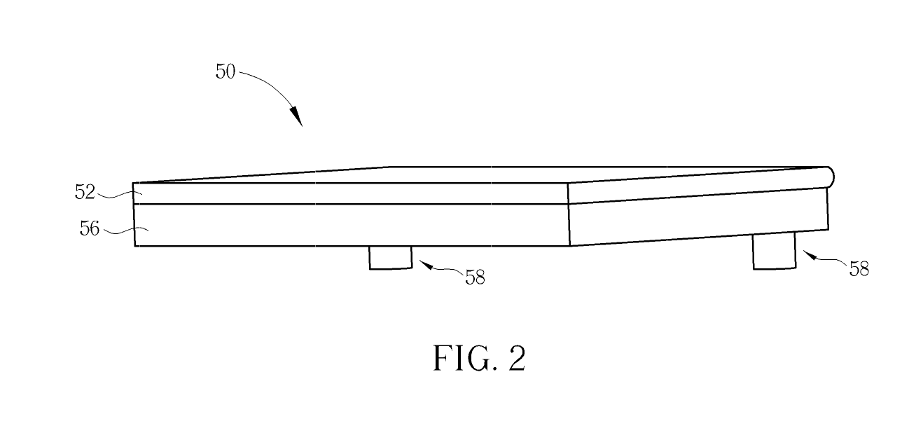

Please refer to FIG. 1 and FIG. 2. FIG. 1 and FIG. 2 are schematic diagrams of a computer device 50 in open and close states according to a preferred embodiment of the present invention. The computer device 50 can be a notebook computer. The computer device 50 includes a first housing 52. The first housing 52 can be a display housing. The computer device 50 further includes at least a first magnetic component 54 installed inside the first housing 52. The first magnetic component 54 can be a magnet such as an electromagnet or a permanent magnet, etc. In this embodiment, the computer device 50 includes two first magnetic components 54 installed on two sides of the first housing 52. Numbers and positions of the first magnetic components 54 are not limited to this embodiment and depend on design demands. The computer device 50 further includes a second housing 56 connected to the first housing 52 in a rotatable manner. That is, the first housing 52 can pivot to the second housing 56, so as to adjust a view angle of a display. The second housing 56 can be a host housing. The computer device 50 further includes at least one pad mechanism 58 connected to a bottom of the second housing 56 and disposed in a position corresponding to the first magnetic component 54. Since the computer device 50 includes two first magnetic components 54 respectively installed on two sides of the first housing 52, and the computer device 50 also includes two pad mechanisms 58 respectively connected to two sides of the second housing 56 to interact with the two first magnetic components 54. Numbers and positions of the pad mechanisms 58 are not limited to this embodiment and depend on design demands. The working principle of one pad mechanism 58 is introduced herein. The pad mechanism 58 can boost the computer device 50, prevent the bottom of the second housing 56 from wearing, and enlarge a gap between the second housing 56 and a supporting surface (such as a desk), so as to improve convection under the computer device 50, such that heat-dissipating efficiency is increased in the entire computer device 50. Furthermore, a tilting angle of a keyboard of the computer device 50 and a height of the display can be adjusted by the pad mechanism 58 to reduce loading of the user's shoulders and neck while typing, so as to conform to the ergonomic design, such that the user can operate the computer device 50 comfortably.

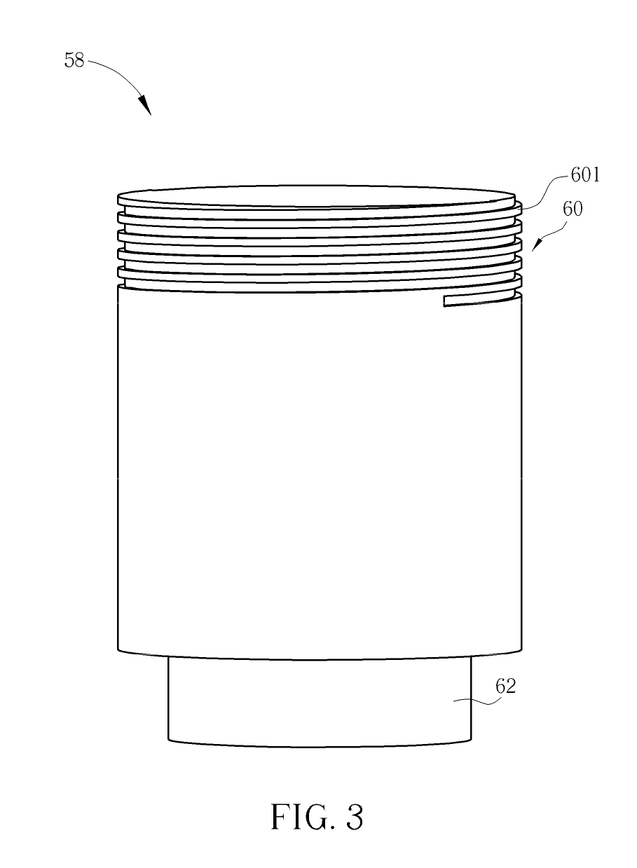

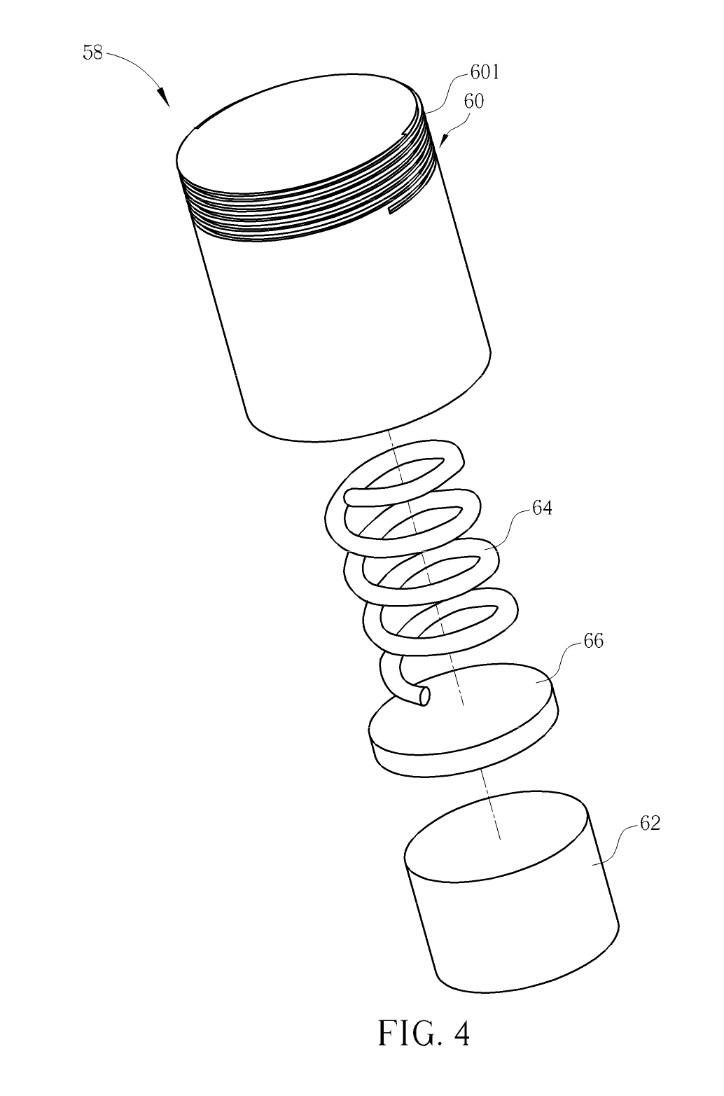

Please refer to FIG. 3 and FIG. 4. FIG. 3 is an assembly diagram of the pad mechanism 58 according to the preferred embodiment of the present invention, and FIG. 4 is an exploded diagram of the pad mechanism 58 according to the preferred embodiment of the present invention. The pad mechanism 58 includes a sleeve 60 connected to a bottom of the second housing 56. A thread structure 601 is disposed on the sleeve 60 for screwing the second housing 56, so as to integrate the pad mechanism 58 with the second housing 56. The sleeve 60 can be made of plastic material. The pad mechanism 58 further includes a pad 62 installed inside the sleeve 60 in a movable manner. The pad 62 can be made of wear-resisting material, such as rubber material, to prevent the bottom of second housing 56 from wearing. The pad mechanism 58 further includes a resilient component 64 installed inside the sleeve 60 in an extensible manner for driving the pad 62 to protrude out of the sleeve 60. The resilient component 64 can be a spring. The pad mechanism 58 further includes a second magnetic component 66 connected to the resilient component 64 and the pad 62 for attracting the first magnetic component 54 disposed inside the first housing 52 so as to drive the pad 62 to hide inside the sleeve 60. The second magnetic component 66 can be a magnet, such as an electromagnet or a permanent magnet, etc.

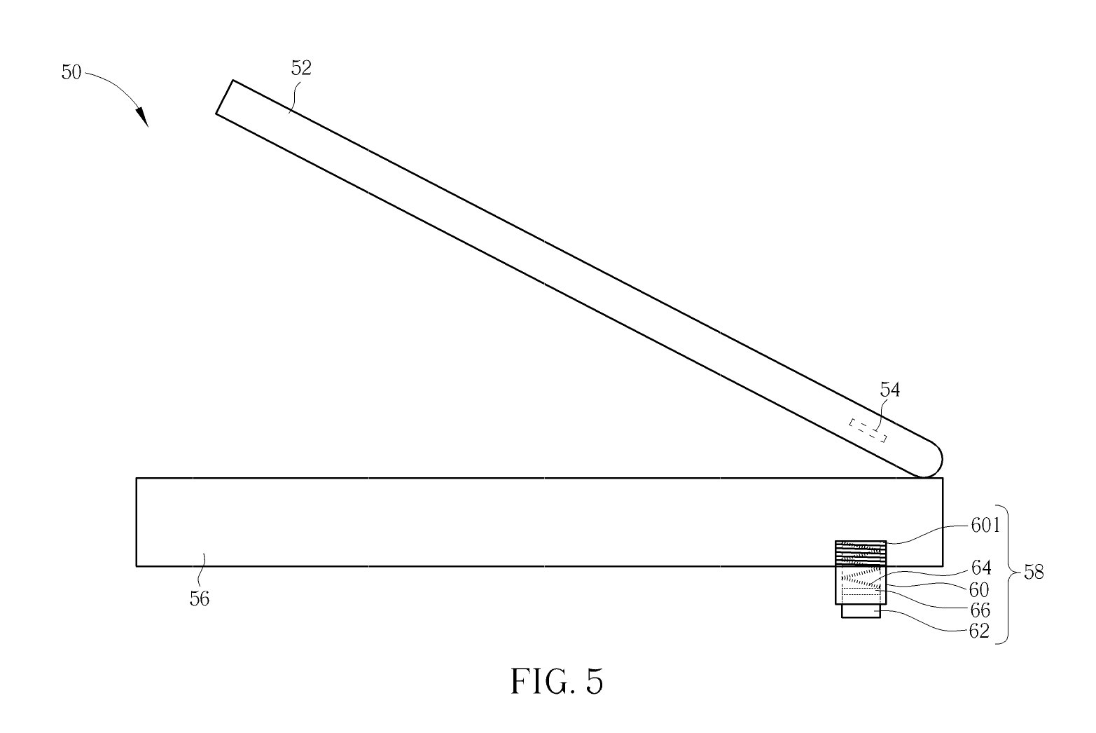

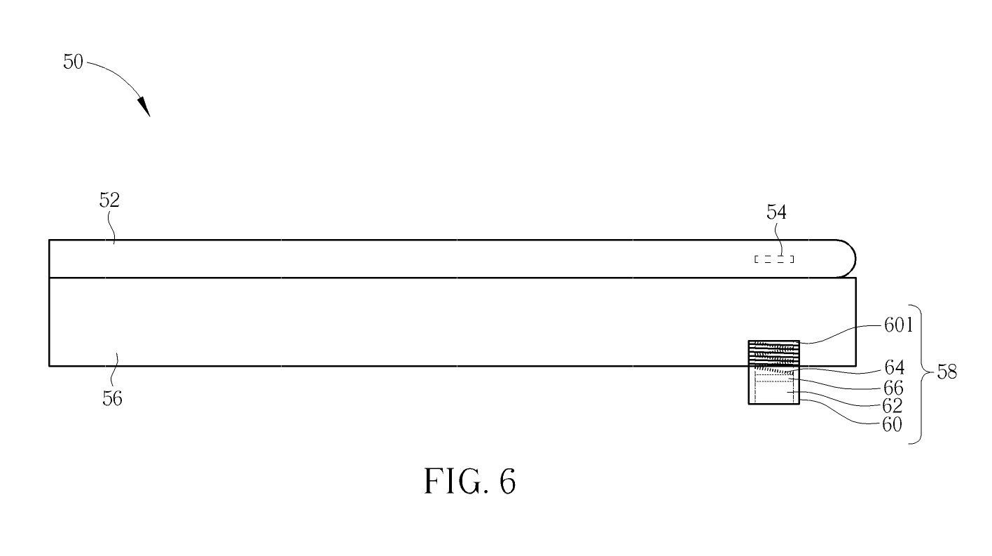

The pad mechanism 58 is introduced hereinafter in different states of the computer device 50. Please refer to FIG. 1 to FIG. 6. FIG. 5 and FIG. 6 are schematic diagrams of inner structure of the computer device 50 in open and close states according to the preferred embodiment of the present invention. When the user rotates the first housing 52 relative to the second housing 56 to open the computer device 50, the angle between the first housing 52 and the second housing 56 gets greater, the first magnetic component 54 disposed inside the first housing 52 gets away from the second magnetic component 66 of the pad mechanism 58, and attractive force between the second magnetic component 66 and the first magnetic component 54 gets smaller. The pad 62 protrudes out of the sleeve 60 to boost the second housing 56 when the attractive force between the second magnetic component 66 and the first magnetic component 54 is less than elastic force applied to the second magnetic component 66 by the resilient component 64. It prevents the bottom of the second housing 56 from wearing, and enlarges the gap between the second housing 56 and the supporting surface so as to improve convection under the computer device 50, such that heat-dissipating efficiency is increased in the entire computer device 50. Furthermore, the design of the pad 62 protruding out of the sleeve 60 to boost the second housing 56 can adjust the tilting angle of the keyboard of the computer device 50 and to increase the height of the display to reduce loading of user's shoulders and neck while typing, as so to meet the ergonomic design, such that the user can operate the computer device 50 comfortably. Besides, the length of the pad 62 protruding out of the sleeve 60 and the angle formed between the first housing 52 and the second housing 56 can be adjusted by changing elasticity of the resilient component 64 (such as changing the material of the resilient component 64) or by changing magnetic force between the second magnetic component 66 and the first magnetic component 54, so as to achieve flexible design of the entire pad mechanism 58.

On the other hand, when the user rotates the first housing 52 relative to the second housing 56 to close the computer device 50, the angle between the first housing 52 and the second housing 56 gets smaller, the first magnetic component 54 disposed inside the first housing 52 gets closer to the second magnetic component 66 of the pad mechanism 58, the attractive force between the second magnetic component 66 and the first magnetic component 54 gets greater. The pad 62 is driven to hide inside the sleeve 60 when the attractive force between the second magnetic component 66 and the first magnetic component 54 is greater than elastic force applied to the second magnetic component 66 by the resilient component 64. When the computer device 50 is not in use, the pad 62 on the bottom of the second housing 56 can be hided inside the sleeve 60 to reduce total thickness of the computer device 50 so as to achieve the aesthetic appearance of the computer device 50 and to reduce space occupied by the pad 62.

In contrast to the prior art, the computer device of the present invention can drive the pad by magnetic force and elastic force. When the display is closed, the pad is hided inside the sleeve due to the attractive force to reduce total thickness of the computer device so as to achieve the aesthetic appearance of the computer device and to reduce space occupied by the pad. When the display is open, the pad protrudes out of the sleeve due to the elastic force to boost the computer device so as to prevent the bottom of the housing from wearing, and to enlarge the gap between the computer device and the supporting surface for improving convection under the computer device, such that heat-dissipating efficiency is increased in the entire computer device. Furthermore, the design of the pad mechanism can adjust the tilting angle of the keyboard of the computer device and the height of the display to reduce loading of the user's shoulders and neck while typing, so as to conform to the ergonomic design, such that the user can operate the computer device comfortably.

Those skilled in the art will readily observe that numerous modifications and alterations of the device and method may be made while retaining the teachings of the invention.

What is claimed is:

1. A computer device comprising:
a first housing;
a first magnetic component installed inside the first housing;
a second housing connected to the first housing in a rotatable manner; and
a pad mechanism connected to the second housing, the pad mechanism comprising:
a sleeve connected to a bottom of the second housing;
a pad installed inside the sleeve in a movable manner;
a resilient component installed inside the sleeve in an extensible manner for driving the pad to protrude out of the sleeve; and
a second magnetic component connected to the resilient component and the pad for attracting the first magnetic component so as to drive the pad to hide inside the sleeve.

2. The computer device of claim 1, wherein a thread structure is disposed on the sleeve for screwing the second housing.

3. The computer device of claim 1, wherein the pad hides inside the sleeve when attractive force between the second magnetic component and the first magnetic component is greater than elastic force applied to the second magnetic component by the resilient component, and the pad protrudes out of the sleeve when attractive force between the second magnetic component and the first magnetic component is less than elastic force applied to the second magnetic component by the resilient component.

4. The computer device of claim 1, wherein the pad completely hides inside the sleeve when the first housing and the second housing are substantially parallel.

5. The computer device of claim 1, wherein the first magnetic component and the second magnetic component are respectively a magnet.

6. The computer device of claim 1, wherein the resilient component is a spring.

7. The computer device of claim 1, wherein the first housing is a display housing.

8. The computer device of claim 1, wherein the second housing is a host housing.
